(19) United States
(12) Patent Application Publication
(10) Pub. No.: US 2007/0283408 A1
(43) Pub. Date: Dec. 6, 2007

(54) Digital television receiver and method for processing broadcast signal

(76) Inventor: Kyung Mee Lee, Seoul (KR)

Correspondence Address: MCKENNA LONG & ALDRIDGE LLP;Song K. Jung, 1900 K Street, N.W., Washington, DC, 20006, US

(21) Appl. No.: 11/806,243

(22) Filed: May 30, 2007

(30) Foreign Application Priority Data
May 30, 2006 (KR) 10-2006-0049053

(51) Int. Cl. H04N 7/025; H04N 7/16; H04N 7/10

(52) U.S. Cl. 725/135; 725/32

(57) ABSTRACT

A method for processing a broadcast signal including current event information, and a broadcast receiver for processing the same are disclosed so that a user can correctly recognize information of a current broadcast event provided via a specific channel. The broadcast receiver analyzes each-channel current broadcast event information contained in the broadcast signal, and provides a user with the analyzed result. The user can correctly recognize the current broadcast event information of a specific channel, and the user can more quickly search for the current broadcast event information of the specific channel.

This application claims the benefit of Korean Patent Application No. 10-2006-0049053, filed on May 30, 2006, which is hereby incorporated by reference as if fully set forth herein.

### BACKGROUND OF THE INVENTION

1. Field of the Disclosure

The present disclosure relates to a digital television (DTV) receiver and a method for processing a broadcast signal.

2. Discussion of the Related Art

Typically, a Program and System Information Protocol (PSIP) is an Advanced Television System Committee (ATSC) standard for terrestrial and cable digital broadcast technologies.

The PSIP transmits broadcast signals encoded by an MPEG-2 system to a broadcast receiver. A digital TV performs parsing of the encoded broadcast signals, and displays a variety of programs.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc. There are a variety of tables, for example, a Master Guide Table (MGT), a Terrestrial Virtual Channel Table (TVCT), a Cable Virtual Channel Table (CVCT), a System Time Table (STT), a Rating Region Table (RRT), an Event Information Table (EIT), and an Extended Text Table (ETT), etc. Conventionally, the PSIP can provide users with a variety of information associated with each of numerous events via an Electronic Program Guide (EPG) service, etc.

However, the term “event” of the above-mentioned PSIP is indicative of a broadcast program unit. Namely, the event is a collection of associated program elements that have a common timeline for a defined period. For example, if there are broadcast programs (i.e., drama1, movie2, and news1), the broadcast programs (i.e., drama1, movie2, and news1) configure a single event.

The EPG is indicative of a program schedule including program- and summary-data of individual channels. The EPG serves as an electronic guide equal to a printed television (TV) program guide, and is generally controlled by a remote controller. Besides, the EPG may order a pay-per-view program, may search for programs for each theme or category, and may record video data, etc.

However, the above-mentioned conventional digital broadcast technology has the following disadvantages.

Firstly, the conventional digital broadcast technology divides a broadcast schedule into predetermined-time spans, and transmits the schedule of predetermined-time span. Therefore, if a live broadcasting time is delayed, unexpected breaking or urgent news or advertisement program is added to transmission data, the possibility of generating errors may unavoidably increase while displaying information of a current broadcast event.

Secondly, if the conventional digital broadcast technology detects information of a current event using only the conventional event information table (EIT), a time consumed for detecting the current event information becomes longer, resulting in greater inconvenience for the user.

### SUMMARY OF THE INVENTION

Accordingly, the present disclosure is directed to a digital television receiver and a method for processing the same that substantially obviate one or more problems due to limitations and disadvantages of the related art.

An object of the present disclosure is to provide a method for processing a broadcast signal including current event information such that a user can correctly recognize information of a current broadcast event provided via a specific channel, and a broadcast receiver for processing the same.

Another object of the present disclosure is to provide a method for processing a broadcast signal including current event information such that a user can quickly search for information of a current broadcast event provided via a specific channel.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of processing a digital broadcast signal in a digital television (DTV) receiver, the method comprising: receiving an event information table (EIT) containing information for events in a predetermined time span, a current event table including identification (ID) information of a plurality of virtual channels and current event information of each virtual channel, and a virtual channel table (VCT) including information of the virtual channels; and acquiring current event information of a specific virtual channel using the virtual channel information contained in the VCT and the virtual channel ID information contained in the current event table.

In another aspect of the present disclosure, there is provided A digital television (DTV) receiver comprising: a demultiplexer for demultiplexing an event information table (EIT) containing information for events in a predetermined time span, a current event table including identification (ID) information of a plurality of virtual channels and current event information of each virtual channel, and a virtual channel table (VCT) including information of the virtual channels; a parser for parsing the demultiplexed table, and decoding the parsed table; and a controller for acquiring current event information of a specific virtual channel using the virtual channel information contained in the VCT and the virtual channel ID information contained in the current event table.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 exemplarily shows a bit stream syntax associated with a Now Event Table (NET);

FIG. 2 exemplarily shows a bit stream syntax of a Terrestrial Virtual Channel Table (TVCT);

FIG. 3 exemplarily shows a bit stream syntax of a Master Guide Table (MGT);

FIG. 4 is a block diagram illustrating a broadcast receiver for receiving/processing a Now Event Table (NET); and

FIG. 5 is a flow chart illustrating a method for processing a broadcast signal.

### DETAILED DESCRIPTION OF THE INVENTION

Reference will now be made in detail to the embodiments of the present disclosure, examples of which are illustrated in the accompanying drawings. Wherever possible, the same reference numbers will be used throughout the drawings to refer to the same or like parts.

For the convenience of description and better understanding of the present disclosure, the present disclosure will sequentially describe a method for determining information of a current broadcast event using a Now Event Table (NET), a broadcast receiver for receiving/processing a Now Event Table (NET), and a method for processing a broadcast signal.

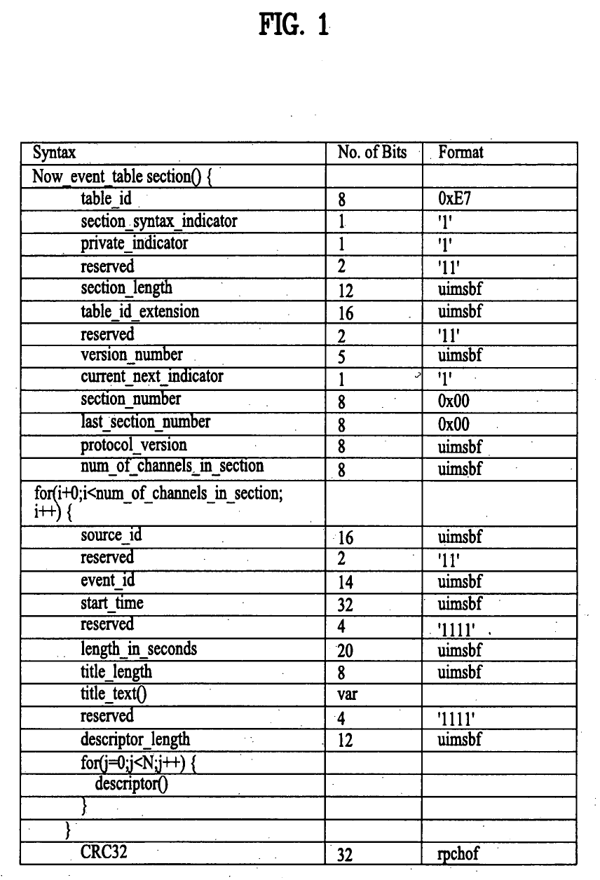

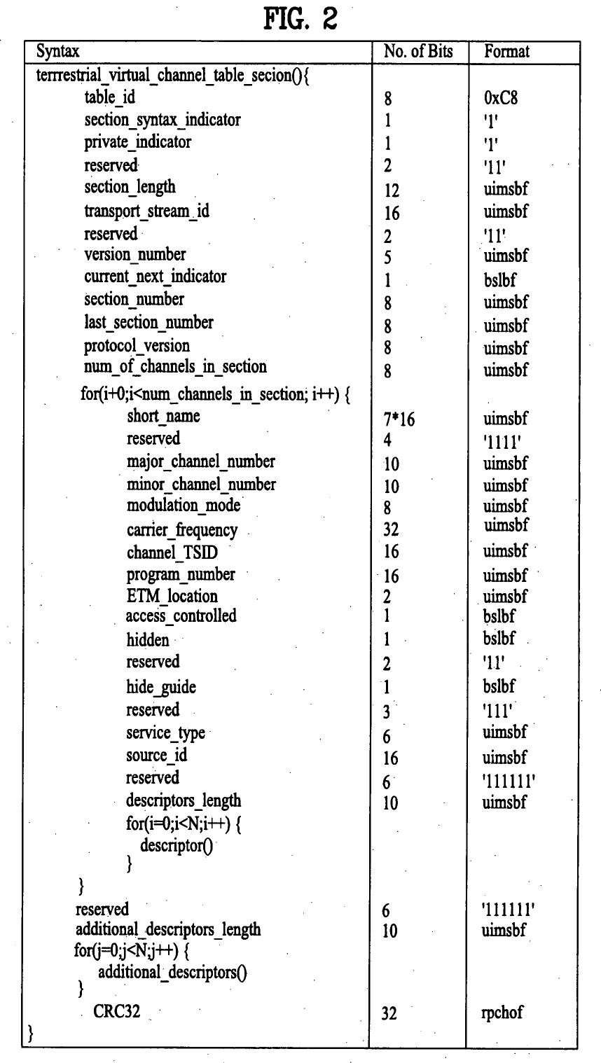

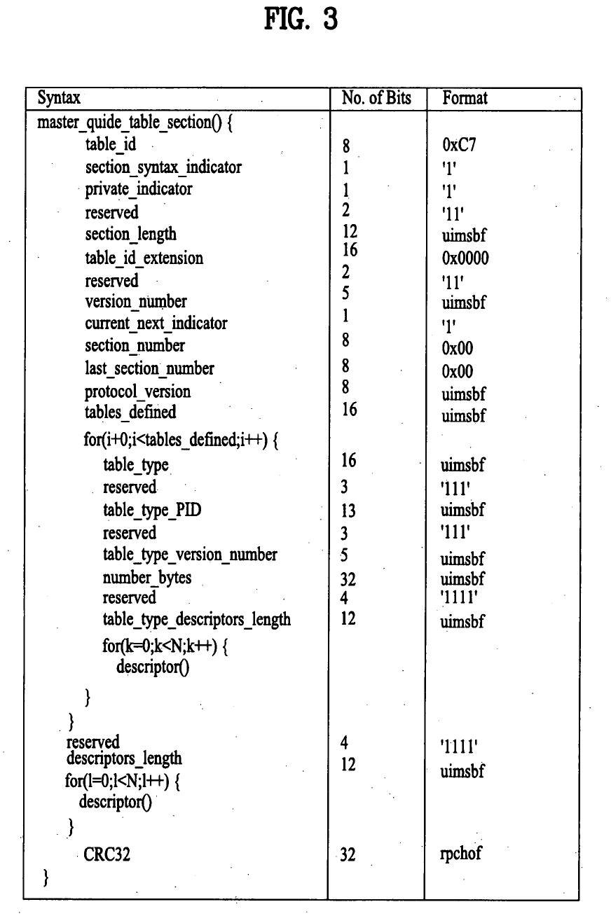

FIG. 1 exemplarily shows a bit stream syntax associated with a Now Event Table (NET). FIG. 2 exemplarily shows a bit stream syntax of a Terrestrial Virtual Channel Table (TVCT). FIG. 3 exemplarily shows a bit stream syntax of a Master Guide Table (MGT). A method for determining current broadcast event information using a Now Event Table (NET) according to the present disclosure will hereinafter be described with reference to FIGS. 1-3. Referring to FIG. 1, a new section-data table not contained in a conventional PSIP (Program and System Information Protocol) will be defined as follows.

The table of FIG. 1 is a table including information of current broadcast events on each virtual channel. For the convenience of description and better understanding of the present disclosure, the above-mentioned table of FIG. 1 is referred to as a Now Event Table (NET). It should be noted that the term “NET” is disclosed for only illustrative purposes, technical characteristic data capable of being understood by those skilled in the art according to the present disclosure may be called other titles as necessary, and belongs to the scope and spirit of the inventive Now Event Table (NET).

The above-mentioned Now Event Table (NET) includes a plurality of fields, and a detailed description thereof will hereinafter be described with reference to FIG. 1.

The “table_id” field includes specific information capable of identifying that a corresponding section belongs to the Now Event Table (NET). The “table_id” field may be designed to have the value of “0xE7”, however, it should be noted that the value of “0xE7” is disclosed for only illustrative purposes, and can also be set to other values. The “section_syntax_indicator” field may be set to the value of ‘1’. In this case, a corresponding section follows generic section syntax beyond the “section_length” field. Namely, the “section_syntax_indicator” field is a 1-bit field set to “1”, such that it denotes that the section follows the generic section syntax beyond the section length field. However, it should be noted that the value of “1” is disclosed for only illustrative purposes, and may also be set to other values as necessary.

The “private_indicator” field is a 1-bit field, and is set to the value of “1”. However, it should be noted that the value of “1” is disclosed for only illustrative purposes, and may also be set to other values as necessary. The “section_length” field includes specific information for identifying the number of remaining bytes of section data under the “section_length” field reaching the last field of this section.

The “table_id_extension” field is a 16-bit field, and is a table-dependent field. The “table_id_extension” field is considered to be a logical part of the “table_id” field for providing the scope of the remaining fields. The “version_number” field is a 5-bit field, and is used as a field for indicating a version number. The “current_next_indicator” field is a 1-bit field, and is designed to have the value of “1”, such that it can be currently applicable.

The “section_number” field is an 8-bit field, and is used to indicate the number of a corresponding section. The “last_section_number” field is an 8-bit field, and is used to identify the number of the last section. The “protocol_version” field is an 8-bit unsigned integer field, such that it carries parameters that may be structured differently from those defined in the current protocol. The “num_of_channels_in_section” field indicates the number of virtual channels defined in the Now Event Table (NET) section.

The “source_id” field identifies a virtual channel associated with the event defined in the “for-loop” syntax of the above-mentioned Now Event Table (NET). In more detail, the “source_id” field is used to map a specific virtual channel from among virtual channels defined in the Terrestrial Virtual Channel Table (TVCT) to a current event defined in the “for-loop” syntax of the Now Event Table (NET). Needless to say, the above-mentioned “source_id” field can also be equally applied to the cable broadcasting for employing a Cable Virtual Channel Table (CVCT) instead of the TCVT. The embodiment of the present disclosure will hereinafter be described on the basis of the Terrestrial Virtual Channel Table (TVCT).

The “event_id” field defines identification (ID) information of a corresponding event. The “start_time” field includes 32 bits, and indicates the start time of the corresponding event. In this case, a GPS-time unit may be used as the start time. The “length_in_seconds” field may indicate a duration time of the corresponding event in units of seconds.

The “title_length” field indicates the length of the “title_text( )” field in byte units. The “title_text( )” field has a multiple string structure, and is used to indicate an event title. The “descriptor_length” field indicates a total length of the next event descriptor in byte units. The “descriptor( )” field indicates at least one descriptor contained in the Now Event Table (NET) under the repeated “for-loop”.

In the meantime, the conventional digital broadcast technology has provided a variety of information of many events at intervals of 3 hours, for example, start time, duration time, and titles of the events. In other words, the conventional event information table (EIT) has schedule information occurred at intervals of 3 hours. The conventional event information table (EIT) includes pre-defined “table_type” information, for example, EIT-0 of a current time span, EIT-1 of the next time span, . . . EIT-127. The “table_type” field is defined in the Master Guide Table (MGT). The Master Guide Table (MGT) is shown in FIG. 3 for the convenience of description.

Each EIT-k can have multiple instances, each of which contains information for one virtual channel, and each of which is identified by the combination of “table_id” and “source_id” fields.

The event information table (EIT) constructs different instances according to respective channels. Therefore, if the user switches a current channel to another channel, there is a need to firstly parse the Master Guide Table (MGT) having a packet ID (PID) and version information of the above-mentioned EIT, such that a variety of information (e.g., title, and start time) of a current broadcast event can be displayed. And, the receiver performs parsing of each instance of the EIT-0, finally receives the system time table (STT), and must check a current time, such that the receiver can recognize which one of events contained in the EIT-0 is currently broadcast.

However, as shown in FIG. 1, if the NET table including information of current events of each channels is independently defined, the current broadcast event information can be more quickly parsed and can also be more accurately checked.

The Now Event Table (NET) according to the present disclosure may be periodically or occasionally transmitted. However, it should be noted that there is no need to transmit the NET at a period shorter than that of the TVCT, because the TVCT is required to check which one of channels is a current broadcast channel.

In the meantime, the principal information of the NET of FIG. 1 may be defined in the MGT of FIG. 3. For example, the NET type may be defined in the “table_type” field of the MGT of FIG. 3, the PID of the NET may be defined in the “table_type_PID” field of the MGT, and the version of the NET may be defined in the “table_type_version_number” field of the MGT.

For example, the “table_type” field of the NET may be set to the value of “0x0007”, and the PID of the NET may be set to a base PID. For example, if the value of “0x1FFB” (i.e., PSIP default PID) is applied to the PID, the filtering action is performed without using the MGT during the channel tuning as in the TVCT, such that the NET can be received. However, it should be noted that the above-mentioned values are disclosed for only illustrative purposes.

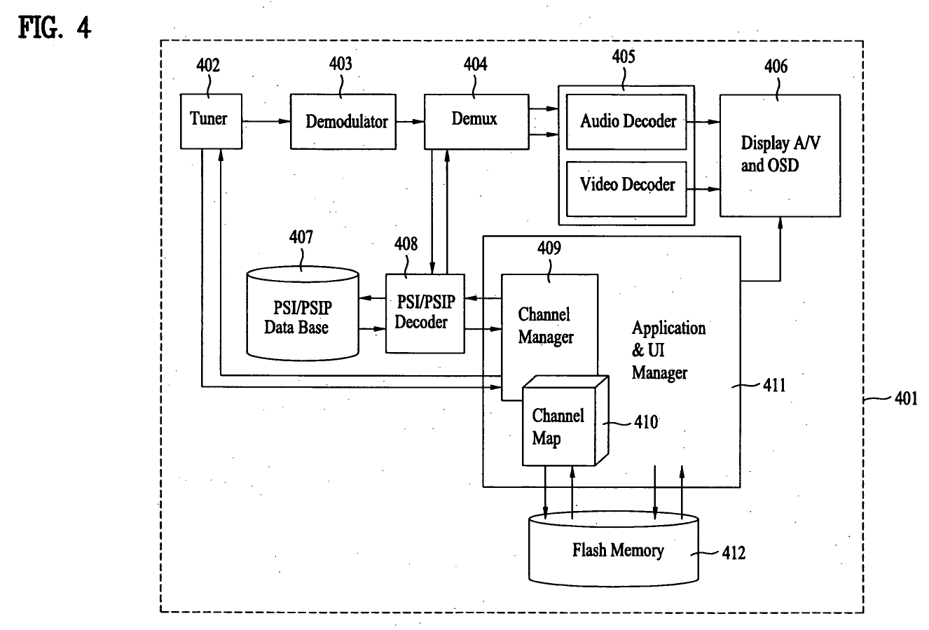

FIG. 4 is a block diagram illustrating a broadcast receiver for receiving/processing a Now Event Table (NET) The broadcast receiver for receiving/processing the NET will hereinafter be described with reference to FIGS. 4 and 1-3.

Referring to FIG. 4, the broadcast receiver 401 includes a tuner 402, a demodulator 403, a demultiplexer 404, an A/V decoder 405, a display 406, a PSI/PSIP database 407, a PSI/PSIP decoder 408, a channel manager 409, a channel map 410, an application controller (i.e., application & UI manager) 411, and a flash memory 412, etc. The broadcast receiver 401 may be set to a digital TV (DTV) capable of receiving digital broadcast data.

The tuner 402 can receive a digital broadcast signal including the PSI/PSIP (Program Specific Information/Program and System Information Protocol) table. Particularly, the PSI/PSIP table includes the Now Event Table (NET) and the Terrestrial Virtual Channel Table (TVCT), etc. The tuner 402 may be controlled by the channel manager 409. The tuner 402 transmits the result of the received digital broadcast signal to the channel manager 409.

The demodulator 403 demodulates the signal tuned by the tuner 402 into a VSB/EVSB (Vestigial Side Band/Enhanced Vestigial Side Band). The demultiplexer 404 demultiplexes the signal demodulated by the demodulator 403 into audio data, video data, and PSI/PSIP table data. The demultiplexing of the audio and video data can be controlled by the channel manager 409. The demultiplexing of the PSI/PSIP table data can be controlled by the PSI/PSIP decoder 408.

The demultiplexer 404 transmits the demultiplexed PSI/PSIP table to the PSI/PSIP decoder 408, and the demultiplexed audio and video data is transmitted to the A/V decoder 405. The A/V decoder 405 decodes the received audio and video data. The PSI/PSIP decoder 408 performs parsing of the PSI/PSIP section, reads the remaining actual section data which has not been section-filtered by the demultiplexer 404, and records the read data in the PSI/PSIP database 407.

The channel manager 409 transmits a request for receiving a channel-associated information table by referring to the channel map 410, and receives the response to the request. In this case, the PSI/PSIP decoder 408 controls the demultiplexing of the channel-associated information table, and transmits the A/V PID (Packet ID) list to the channel manager 409. The channel manager 409 controls the demultiplexer 404 using the transmitted A/V PID list, such that the A/V decoder 405 is controlled. The application controller 411 controls a Graphical User Interface (GUI) for displaying status information of the broadcast receiver system on the OSD (On Screen Display).

Particularly, according to the present disclosure, the demultiplexer 404 demultiplexes the Now Event Table (NET) and the Terrestrial Virtual Channel Table (TCVT), and transmits the demultiplexed result to the PSI/PSIP decoder 408. The Now Event Table (NET) according to the present disclosure can be readily understood by the above-mentioned embodiments. As described above, if the PID of the Now Event Table (NET) is set to the base PID (i.e., “0x1FFB” or PSIP default PID), the demultiplexer 404 can receive the NET by performing the section filtering.

The PSI/PSIP decoder 408 determines whether the PSI/PSIP database 407 has a pre-parsed TVCT. If the presence of the pre-parsed TVCT is determined, the PSI/PSIP decoder 408 parses the NET and constructs a database. The PSI/PSIP database 407 stores the parsed NET information.

The application manager 411 can check information of a current tuning channel using the “source_id” field contained in the NET of FIG. 1. Therefore, the application manager 411 can quickly and accurately check the start time of the event generated from the current tuning channel using the “start_time” field, the duration time of the event using the “length_in_seconds” field, and title information of the event using the “title_text” field. The application manager 411 controls for displaying the start time, duration time, and title information of the current event on the display 406.

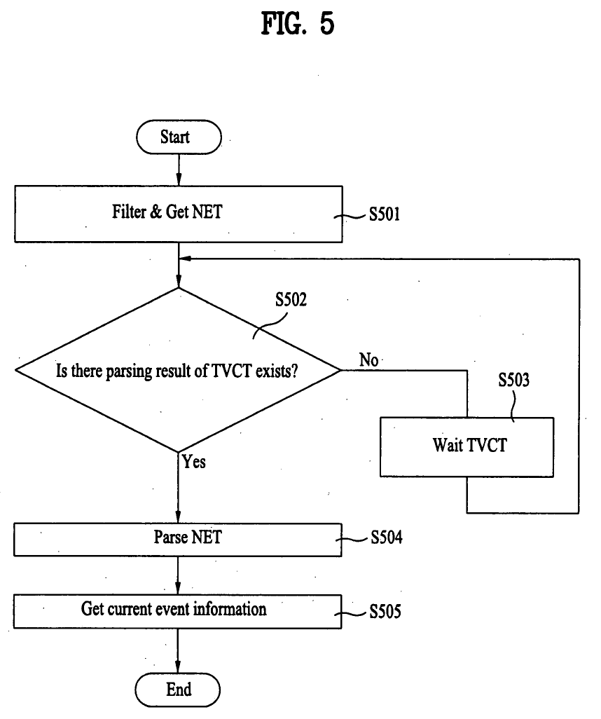

FIG. 5 is a flow chart illustrating a method for processing a broadcast signal. A method for processing a broadcast signal according to the present disclosure will hereinafter be described with reference to FIGS. 5, and 1-4.

Referring to FIG. 5, the broadcast receiver filters the received broadcast signal, and receives the Now Event Table (NET) contained in the broadcast signal at step S501. In this case, the NET's PID may be set to the base PID (i.e., 0x1FFB or PSIP default PID).

The broadcast receiver determines the presence of parsed Terrestrial Virtual Channel Table (TCVT) information at step S502. Needless to say, the order of step S501 and step S502 can be changed as necessary.

If the parsed TVCT information does not exist at step S502, the broadcast receiver waits to receive the TVCT at step S503. Otherwise, if the parsed TVCT information exists at step S502, the broadcast receiver parses the received NET at step S504.

The receiver can correctly acquire start time, duration time, and title information of the current event generated from the current tuning channel using the above-mentioned TVCT and NET information at step S505. In addition, the receiver may display the information acquired at step S505 on a screen upon receiving a request from the user. In other words, the receiver displays the result of the above-mentioned acquired information, resulting in greater convenience for the user.

As apparent from the above description, the present disclosure provides a method for processing a broadcast signal including current event information such that a user can correctly recognize information of a current broadcast event provided via a specific channel, and also provides a broadcast receiver for processing the same.

The present disclosure defines an additional NET, such that it can correctly determine current broadcast event information of a specific channel. The present disclosure can check the NET without using the MGT using the base PID, such that it can more quickly search for current broadcast event information of a specific channel.

It should be noted that most terminology disclosed in the present disclosure is defined in consideration of functions of the present disclosure, and can be differently determined according to intention of those skilled in the art or usual practices. Therefore, it is preferable that the above-mentioned terminology be understood on the basis of all contents disclosed in the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method of processing a digital broadcast signal in a digital television (DTV) receiver, the method comprising:
receiving an event information table (EIT) containing information for events in a predetermined time span, a current event table including identification (ID) information of a plurality of virtual channels and current event information of each virtual channel, and a virtual channel table (VCT) including information of the virtual channels; and
acquiring current event information of a specific virtual channel using the virtual channel information contained in the VCT and the virtual channel ID information contained in the current event table.

2. The method of claim 1, further comprising displaying the current event information of the specific virtual channel on a screen.

3. The method of claim 1, wherein the current event table is a newly-defined table.

4. The method of claim 1, wherein the current event table is received at a period greater than that of the VCT.

5. The method of claim 1, wherein receiving a current event table comprises filtering the current event table using a predefined packet identifier (PID).

6. The method of claim 1, wherein receiving a current event table comprises acquiring a packet identifier (PID) of the current event table by parsing a master guide table (MGT), and filtering the current event table using the acquired packet identifier (PID).

7. The method of claim 1, wherein the VCT is a terrestrial virtual channel table (TVCT).

8. The method of claim 1, wherein the VCT is a cable virtual channel table (CVCT).

9. The method of claim 1, wherein the current event information includes an information field specifying a start time of a current event associated with each virtual channel.

10. The method of claim 1, wherein the current event information includes an information field specifying duration time of a current event associated with each virtual channel.

11. The method of claim 1, wherein the current broadcast event information includes an information field specifying a title of a current event associated with each virtual channel.

12. A digital television (DTV) receiver comprising:
a demultiplexer for demultiplexing an event information table (EIT) containing information for events in a predetermined time span, a current event table including identification (ID) information of a plurality of virtual channels and current event information of each virtual channel, and a virtual channel table (VCT) including information of the virtual channels;
a parser for parsing the demultiplexed table, and decoding the parsed table; and
a controller for acquiring current event information of a specific virtual channel using the virtual channel information contained in the VCT and the virtual channel ID information contained in the current event table.

13. The digital television receiver of claim 12, wherein the controller displays the current event information of the specific virtual channel on a screen.

14. The digital television receiver of claim 12, wherein the current event table is a newly-defined table.

15. The digital television receiver of claim 12, wherein the current event table is received at a period greater than that of the VCT.

16. The digital television receiver of claim 12, wherein the demultiplexer demultiplexes a current event table using a predefined packet identifier (PID).

17. The digital television receiver of claim 12, wherein the demultiplexer demultiplexes a current event table using an acquired packet identifier (PID) of the current event table from a master guide table (MGT).

18. The digital television receiver of claim 12, wherein the VCT is a terrestrial virtual channel table (TVCT).

19. The digital television receiver of claim 12, wherein the VCT is a cable virtual channel table (CVCT).

20. The digital television receiver of claim 12, wherein the current event information includes an information field specifying a start time of a current event associated with each virtual channel.

21. The digital television receiver of claim 12, wherein the current event information includes an information field specifying duration time of a current event associated with each virtual channel.

22. The digital television receiver of claim 12, wherein the current event information includes an information field specifying a title of a current event associated with each virtual channel.
